(19) United States
(12) Patent Application Publication
(10) Pub. No.: US 2006/0210762 A1
(43) Pub. Date: Sep. 21, 2006

(54) Rigid subtrates having molded projections, and methods of making the same

(76) Inventor: Ernesto S. Tachauer, Bedford, NH (US)

Correspondence Address: FISH & RICHARDSON PC, P.O. BOX 1022, MINNEAPOLIS, MN, 55440-1022, US

(21) Appl. No.: 11/082,384

(22) Filed: Mar. 17, 2005

(51) Int. Cl. B32B 3/06

(52) U.S. Cl. 428/99; 264/166

(57) ABSTRACT

Rigid substrates having molded fastener projections, and methods of making the same are disclosed. A substrate has a beam stiffness, measured as a product of an overall moment of inertia of a nominal transverse cross-section and an effective modulus of elasticity of a material from which the substrate is made, that is greater than about 200 lb-in² (0.574 N-m²).

### TECHNICAL FIELD

This invention relates to rigid substrates having molded fastener projections, and methods of making the same.

### BACKGROUND

Early male touch fastener products were generally woven materials, with hooks formed by cutting filament loops. More recently, arrays of small fastener elements have been formed by molding the fastener elements, or at least the stems of the elements, of resin, forming an interconnected sheet of material. Generally, molded plastic hook tape has displaced traditional woven fabric fasteners for many applications, primarily because of lower production costs.

Molded plastic hook tape is often attached to substrates by employing an adhesive, or by sewing when the substrate is a made from sewable material. Often, adhesive-backed hook tape is utilized to attach the hook tape at desired locations on the substrate. Unfortunately, the process of applying adhesive-backed hook tape can be slow, and adhesion of the adhesive-backed hook tape to the substrate can be poor.

### SUMMARY

Generally, the invention relates to rigid substrates having molded fastener projections, e.g., hooks or stems from which fastener elements can be formed, and methods of making the same.

In one aspect, the invention features a method of molding projections on a substrate. The method includes introducing a substrate having an outer surface into a gap formed between a peripheral surface of a rotating mold roll that defines a plurality of discrete cavities that extend inwardly from the peripheral surface, and a supporting surface. Resin is delivered to a nip formed between the outer surface of the substrate and the peripheral surface of the rotating mold roll. The outer surface of the substrate and the peripheral surface of the rotating mold roll are arranged to generate sufficient pressure to at least partially fill the cavities in the mold roll as the substrate is moved through the gap to mold an array of discrete projections including stems that extend integrally from a layer of the resin bonded to the substrate. The molded projections are then withdrawn from their respective cavities by separation of the peripheral surface of the mold roll from the outer surface of the substrate by continued rotation of the mold roll. The substrate has a beam stiffness, measured as a product of an overall moment of inertia of a nominal transverse cross-section and an effective modulus of elasticity of a material from which the substrate is formed, that is greater than about 200 lb-in² (0.574 N-m²).

In some embodiments, the beam stiffness is greater than 1,000 lb-in² (2.87 N-m²), e.g., 4,000 lb-in² (11.48 N-m²) or more, e.g., 8,000 lb-in² (22.96 N-m²).

In some instances, the effective modulus of elasticity of the material from which the substrate is formed is greater than 100,000 psi (6.89×10⁸ N/m²), e.g., 250,000 psi (1.72×10⁹N/m²), 750,000 psi (5.17×10⁹ N/m²), 1,000,000 psi (6.89×10⁹ N/m²) or more, e.g., 5,000,000 psi (3.45×10¹⁰ N/m²), 15,000,000 psi (1.03×10¹¹ N/m²) or more, e.g., 30,000,000 psi (2.07×10¹¹ N/m²).

In some implementations, the supporting surface is a peripheral surface of a counter-rotating pressure roll or a fixed pressure platen.

In some embodiments, the cavities of the mold roll are shaped to mold hooks so as to be engageable with loops. In other embodiments, the cavities of the mold roll are shaped to mold hooks, and the hooks are reformed after molding.

In some instances, each projection defines a tip portion, and the method further includes deforming the tip portion of a plurality of projections to form engaging heads shaped to be engageable with loops, or other projections, e.g., of a complementary substrate.

In some embodiments, the resin is delivered directly to the nip. In some implementations, the resin is delivered first to the outer surface of the substrate upstream of the nip, and then the resin is transferred to the nip, e.g., by rotation of the mold roll.

The substrates can have a variety of shapes, e.g., the substrate can have an “L” shape, “T” shape or “U” shape in transverse cross-section.

In some embodiments, the method further includes introducing another resin beneath the resin such that the other resin becomes bonded to the outer surface of the substrate and the resin becomes bonded to an outer surface of the other resin.

The substrate can have, e.g., an average surface roughness of greater than 1 micron, e.g., 2 micron, 4 micron, 8 micron, 12 micron or more, e.g., 25 micron.

In some implementations, the substrate is formed from more than a single material.

In some instances, the projections have a density of greater than 300 projections/in² (46.5 projections/cm²).

In some embodiments, the method further comprises pre-heating the substrate prior to introducing the substrate into the gap, or priming the substrate prior to introducing the substrate into the gap.

In another aspect, the invention features a method of molding projections on a substrate. The method includes introducing a substrate, e.g., a linear substrate, having an outer surface into a gap formed between a peripheral surface of a rotating mold roll that defines a plurality of discrete cavities that extend inwardly from the peripheral surface, and a supporting surface. The resin is delivered to a nip formed between the outer surface of the substrate and the peripheral surface of the rotating mold roll. The outer surface of the substrate and the peripheral surface of the rotating mold roll are arranged to generate sufficient pressure to at least partially fill the cavities in the mold roll as the substrate is moved through the gap to mold an array of discrete projections including stems extending integrally from a layer of the resin bonded to the substrate. The molded projections are withdrawn from their respective cavities by separation of the peripheral surface of the mold roll from the outer surface of the substrate by continued rotation of the mold roll. The substrate has a beam stiffness sufficiently great that during withdrawal of the molded projections from their respective cavities, the substrate remains substantially linear.

In some embodiments, the beam stiffness of the substrate, measured as a product of an overall moment of inertia of a nominal transverse cross-section and an effective modulus of elasticity of material of the substrate, is greater than about 200 lb-in² (0.574 N-m²).

In another aspect, the invention features an article having molded fastening projections. The article includes a substrate and an array of discrete molded projections including stems extending outwardly from and integrally with a molded layer of resin solidified about surface features of the substrate, and thereby securing the projections directly to the substrate. The substrate has a beam stiffness, measured as a product of an overall moment of inertia of a nominal transverse cross-section and an effective modulus of elasticity of a material from which the substrate is made, that is greater than about 200 lb-in² (0.574 N-m²).

In some embodiments, the beam stiffness is greater than about 1,000 lb-in² (2.87 N-m²), e.g., 4,000 lb-in² (11.48 N-m²).

Embodiments may have one or more of the following advantages. Projections can be integrally molded onto substrates, e.g., substrates useful in construction, e.g., wallboard, window frames, panels, or tiles, without the need for using an adhesive, often reducing manufacturing costs, e.g., by reducing labor costs and increasing throughput. Integrally molding projections often improves adhesion of the molded projections to the substrate and reduces the likelihood of delamination of the molded projections from the substrate during the application of a force, e.g., a peeling force, or a shear force.

All publications, patent applications, patents, and other references mentioned herein are incorporated by reference herein in their entirety.

Other features and advantages of the invention will be apparent from the following detailed description, and from the claims.

### DESCRIPTION OF DRAWINGS

FIG. 1 is a side view of a process for molding hooks onto a T-shaped substrate, the process utilizing a fixed pressure platen as a supporting surface for the T-shaped substrate.

FIG. 1A is a cross-sectional view taken along 1A-1A of FIG. 1.

FIG. 1B is an enlarged side view of Area 1B of FIG. 1.

FIG. 1C is a cross-sectional view taken along 1C-1C of FIG. 1.

FIG. 2 is a side view of an alternative process for molding hooks onto a substrate, the process utilizing a counter-rotating pressure roll as support for the substrate.

FIG. 2A is an enlarged side view of a reforming roll (Area 2A) of FIG. 2.

FIG. 3 is a side view of a process for molding stems onto a substrate.

FIG. 3A is an enlarged side view of Area 3A of FIG. 3, showing a substrate having molded stems.

FIG. 4 is a side view of a process for reforming the molded stems of FIG. 3 to form engageable projections shaped to be engageable with loops (FIG. 4B) or other projections.

FIG. 4A is an enlarged side view of Area 4A of FIG. 4.

FIG. 4B is an enlarged cross-sectional view of a substrate carrying fibrous loops.

FIG. 4C is a side view of two substrates having deformed molded stems, illustrating how the two substrates can engage each other.

FIG. 5 is a side view of a process for molding hooks onto a substrate that utilizes a tie layer.

FIG. 5A is an enlarged side view of Area 5A of FIG. 5.

FIGS. 6 and 7 are cross-sectional views of planar, laminated substrates, having two and three layers, respectively.

FIG. 8A is a cross-sectional view of an L-shaped substrate having hooks in which heads are directed in a single direction, and FIG. 8B is a perspective view of the L-shaped substrate of FIG. 8A.

FIG. 9 is cross-sectional view a U-shaped substrate having molded projections.

Like reference symbols in the various drawings indicate like elements.

### DETAILED DESCRIPTION

Rigid substrates having molded fastener projections, and methods of making the same are described herein. Generally, the substrates have a beam stiffness that is sufficiently great such that during withdrawal of the molded projections from their respective cavities, the substrate remains substantially straight, and does not bend away from its support.

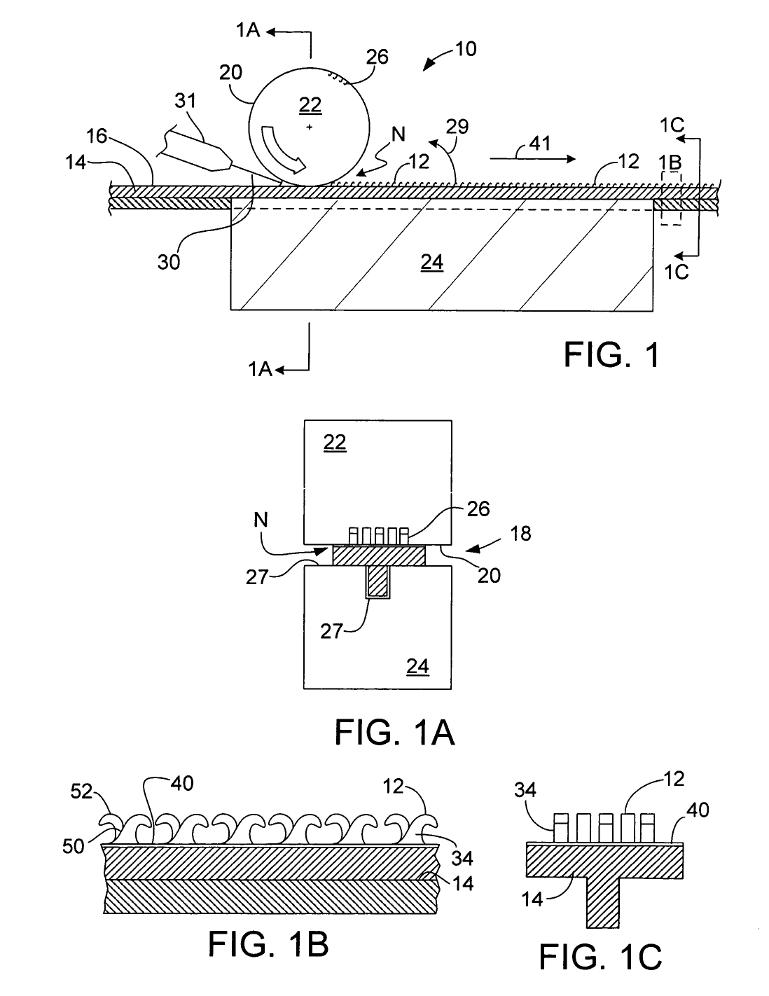

Referring collectively to FIGS. 1 and 1A-1C, a process 10 for integrally molding projections, e.g., hooks 12, onto a substrate 14, e.g., a T-shaped substrate, includes introducing the substrate 14 that has an outer surface 16 into a gap 18 formed between a peripheral surface 20 of a rotating mold roll 22 and a fixed pressure platen 24 that has a supporting surface 27. The mold roll 22 defines a plurality of discrete cavities, e.g., cavities 26 in the shape of hooks, that extend inwardly from peripheral surface 20 of the rotating mold roll 22. An extruder (not shown) pumps resin 30, e.g., molten thermoplastic resin, through a die 31 where it is delivered to a nip N formed between outer surface 16 of the substrate and peripheral surface 20 of the rotating mold roll 22. The outer surface 16 of the substrate 14 and peripheral surface 20 of rotating mold roll 22 are arranged to generate sufficient pressure to fill the cavities in the mold roll 22 as substrate 14 is moved through gap 18 to integrally mold an array of discrete hooks 12, including stems 34, which extend outwardly from and are integral with a layer 40 that is bonded to outer surface 16. The molded hooks 12 are withdrawn from their respective cavities 26 by separation of the peripheral surface 20 of the mold roll 22 from outer surface 16 of substrate 14 by continued rotation of mold roll 22. Substrate 14 has a beam stiffness sufficiently great such that during withdrawal of hooks 12 from their respective cavities, the substrate 14 remains substantially linear, and is not bent away from the supporting surface 27 of fixed pressure platen 24 toward moll roll 22 (indicated by arrow 29). For example, substrate 14 has a beam stiffness, measured as a product of an overall moment of inertia of a nominal transverse cross-section and an effective modulus of elasticity (Young's modulus) of a material from which the substrate is formed, that is, e.g., greater than 1,000 lb-in² (2.87 N-m²), e.g., 4,000 lb-in² (11.48 N-m²) or greater, e.g., 8,000 lb-in² (22.96 N-m²). The effective modulus of elasticity of the material from which the substrate is formed is measured using ASTM E111-04 at 25° C. at fifty percent relative humidity, allowing sufficient time for moisture and temperature equilibration.

In some implementations, the outer surface 16 of substrate 14, the peripheral surface 20 of the rotating mold roll 22 and the resin 30 are arranged to generate sufficient friction such that the substrate 14 is pulled into and moved through gap 18, in a direction indicated by arrow 41, by continued rotation of mold roll 22.

In some embodiments, mold roll 22 includes a face-to-face assembly of thin, circular plates or rings (not shown) that are, e.g., about 0.003 inch to about 0.250 inch (0.0762 mm-6.35 mm) thick, some rings having cutouts in their periphery that define mold cavities, and other rings having solid circumferences, serving to close the open sides of the mold cavities and to serve as spacers, defining the spacing between adjacent projections. In some embodiments, adjacent rings are configured to mold hooks 12 such that alternate rows 50, 52 (FIG. 1B) have oppositely directed heads. A fully “built up” mold roll may have a width, e.g., from about 0.75 inch to about 24 inches (1.91 cm-61.0 cm) or more and may contain, e.g., from about 50 to 5000 or more individual rings. Further details regarding mold tooling are described by Fisher, U.S. Pat. No. 4,775,310, the disclosure of which is hereby incorporated by reference herein in its entirety.

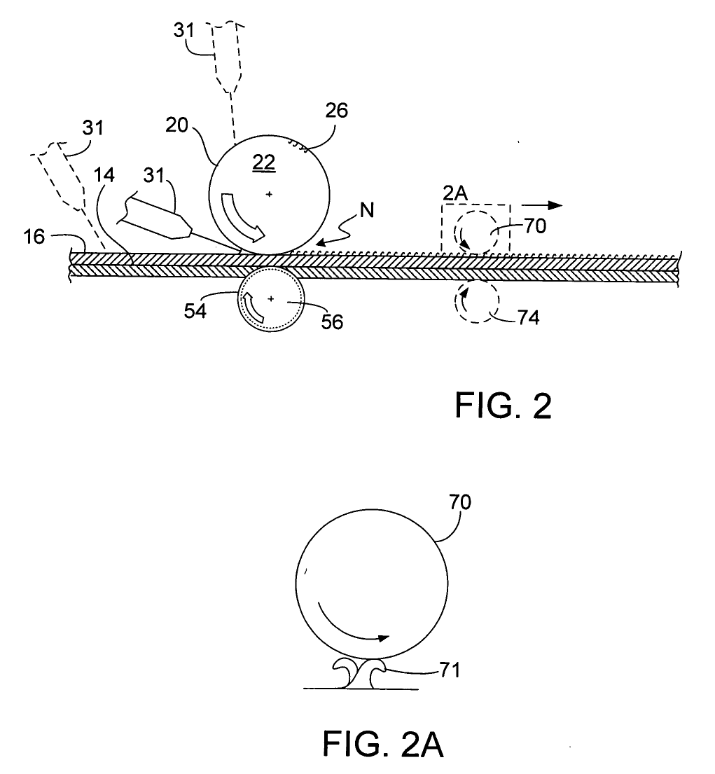

Referring to FIG. 2, in an alternative embodiment, the supporting surface for substrate 14 is a peripheral surface 54 of a counter-rotating pressure roll 56. As discussed above, an extruder (not shown) pumps resin through die 31 and delivers the resin 30 to nip N to mold an array of discrete hooks 12 extending integrally from layer 40 that is bonded to the substrate. While an extruder (not shown) can pump resin 30 directly into the nip N, other points of delivery are possible. For example, as shown in FIG. 2, rather than delivering resin directly to nip N, extruder die 31 can be positioned to deliver resin 30 first to the outer surface 16 of substrate 14 upstream of the nip N. In this embodiment, resin 30 is transferred to nip N by moving substrate 14 through gap 18. This can be advantageous, e.g., when it is desirable that the resin 30 be somewhat set, e.g., cooled, prior to entering the nip N. In other embodiments, also as shown in FIG. 2, extruder die 31 is positioned to deliver resin 30 first to the outer surface 20 of the rotating mold roll 22. In this implementation, resin 30 is transferred to the nip N by rotation of the mold roll 22.

Referring particularly to FIG. 2A, in some instances, hooks 71 remain slightly deformed after being withdrawn from their respective cavities during separation of the peripheral surface 20 from the outer surface 16 of substrate 14. To return these hooks to their as-molded shape, the process shown in FIG. 2 can optionally include a reforming roll 70 that reforms deformed hooks 71 with pressure and, optionally, heat as the molded hooks move below the reforming roll 70. In some instances, it is desirable that the reforming roll 70 be rotated such that it has a tangential velocity that is higher than, e.g., ten percent higher or more, e.g., twenty-five percent higher, than the velocity of the substrate 14 to aid in the reforming of the deformed hooks. In some instances, reforming roll 70 can be used to maintain substrate 14 in a substantially linear state, by hindering movement of substrate 14 toward the mold roll.

In some embodiments, the process shown in FIG. 2 can optionally include a counter rotating nip-roller 74 in conjunction with the reforming roll 70 to aid in the moving of substrate 14 through gap 18.

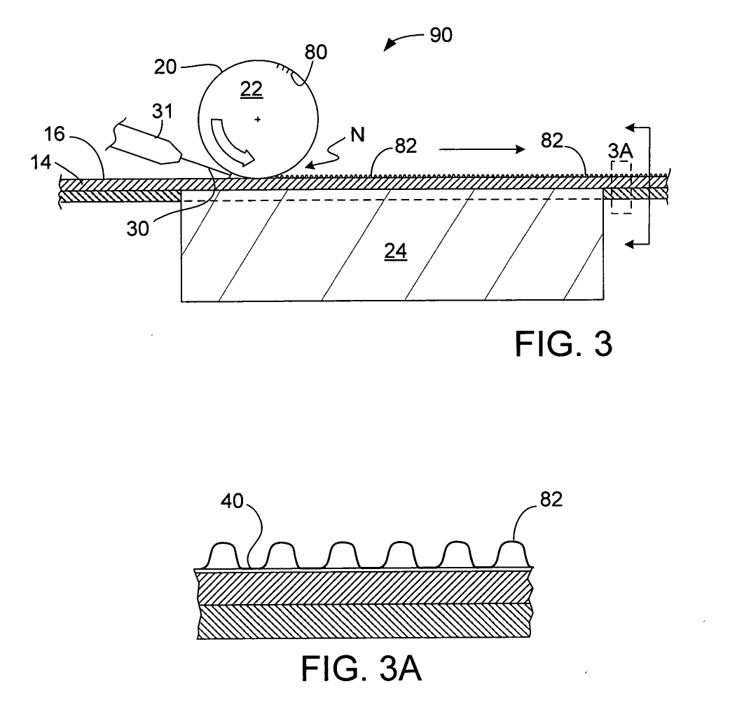

Referring now to FIGS. 3 and 3A, in an alternative embodiment, a process 90 for integrally molding projections in the shape of stems 82 onto substrates includes a mold roll 22 that defines a plurality of discrete cavities 80 in the shape of stems 82 that extend inwardly from a peripheral surface 20 of the rotating mold roll 22. In some instances, removal of molded projections that are in the shape of stems 82 from a mold roll can be easier (relative to projections in the shape of hooks) because the mold roll does not have cavities that have substantial undercuts. As a result, substrate 14 can often have a lower beam stiffness (relative to embodiments of FIGS. 1 and 2) and-still remain substantially linear during withdrawal of the stems 82 from their respective cavities 80. For example, the substrate can have a beam stiffness that is, e.g., greater than 200 lb-in² (0.574 N-m²), e.g., 1,000 lb-in² (2.87 N-m²).

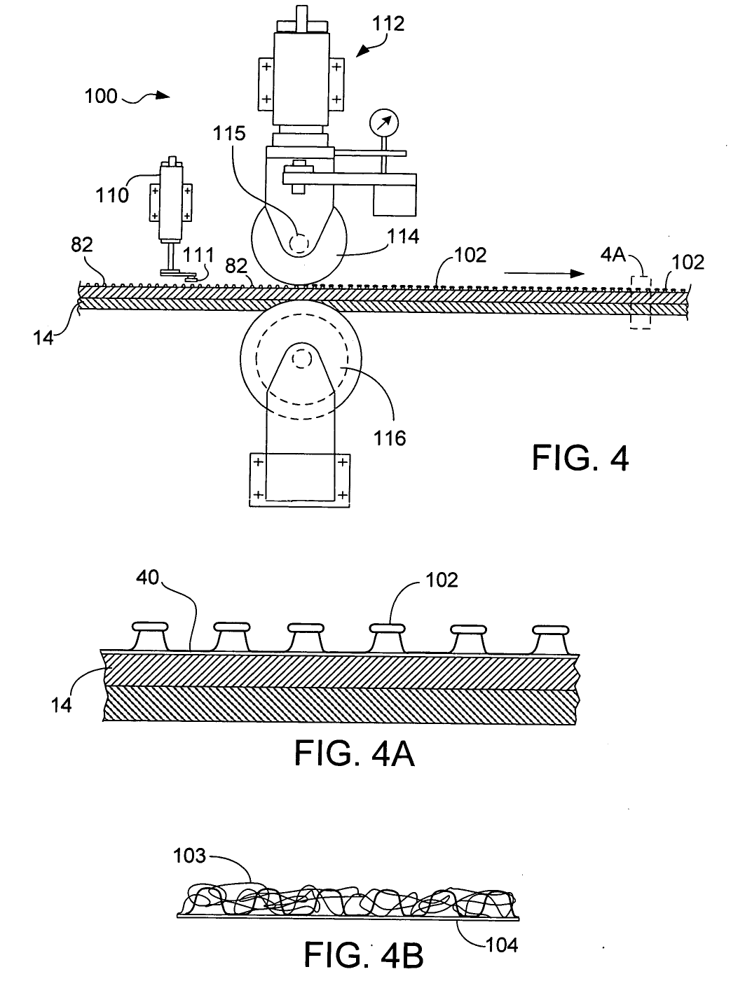

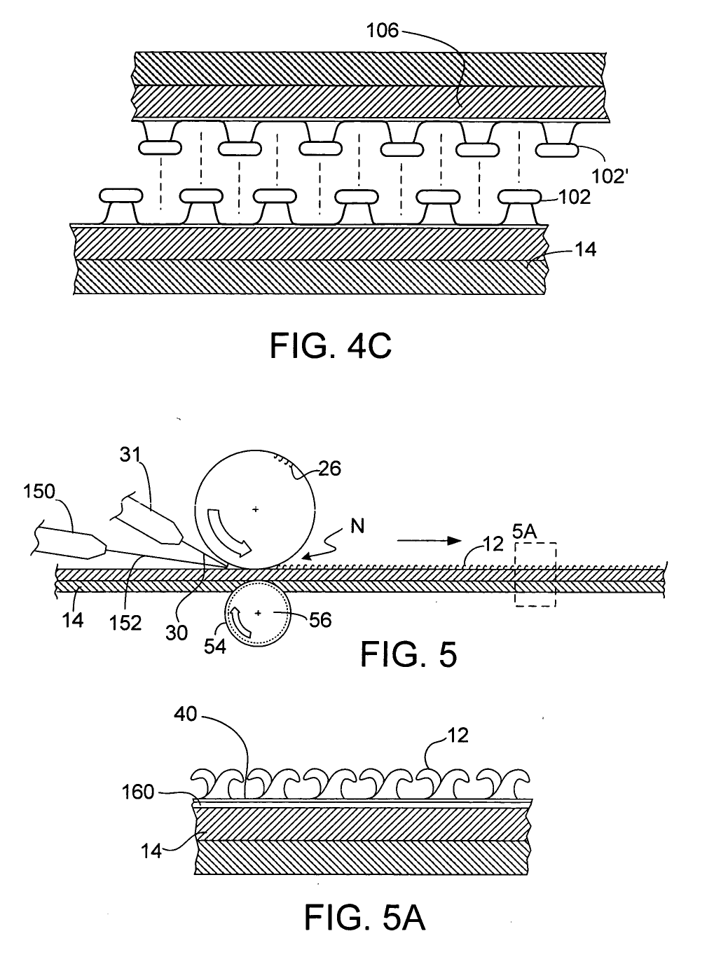

Referring to FIGS. 4-4C, the projections in the shape of stems 82 that were integrally molded to substrate 14 by the process shown in FIG. 3 can be deformed (such as when a thermoformable resin is employed to mold the stems) by a deforming process 100. Process 100 can form engaging heads 102 shaped to be engageable with loops 103 that extend from a base 104 of a mating material (FIG. 4B), or that are engageable with other projections 102′ of a mating substrate 106 (FIG. 4C).

Referring particularly to FIG. 4, a heating device 110 includes a heat source 111, e.g., a non-contact heat source, e.g., a flame, an electrically heated wire, or radiant heat blocks, that is capable of quickly elevating the temperature of material that is close to heat source 111, without significantly raising the temperature of material that is further away from heat source 111. After heating the stems 82, the substrate moves to conformation station 112, passing between conformation roll 114 and drive roll 116. Conformation roll 114 deforms stems 82 to form engageable heads 102, while drive roll 116 helps to advance the substrate.

It is often desirable to chill the conformation roll, e.g., by running cold water through a channel 115 in the center of roll 114, to counteract heating of conformation roll 114 by the heat of the resin. Process 100 can be performed in line with the process shown in FIG. 3, or it can be performed as a separate process. Further details regarding this deforming process are described by Clarner, U.S. patent application Ser. No. 10/890,010, filed Jul. 13, 2004, the entire contents of which are incorporated by reference herein.

Referring now to FIGS. 5 and 5A, in an alternative embodiment, an extruder (not shown) pumps resin 30 through die 31, and delivers resin 30 to nip N formed between outer surface 16 of substrate 14 and peripheral surface 20 of rotating mold roll 22. At the same time, a second extruder (not shown) pumps another resin 152 through another die 150, and delivers the other resin to the nip N such that the other resin 152 is disposed underneath the resin 30, becoming bonded to the outer surface 16 of substrate 14 (forming layer 160, e.g., a tie layer), while the resin 30 becomes bonded to an outer surface of the other resin 152. This is often advantageous, e.g., when adhesion of resin 30 to surface 16 is poor. In some embodiments, a maleated polypropylene, or a blend of maleated polypropylene and polypropylene is used as other resin 152, and polypropylene is used as resin 30.

In any of the above embodiments, suitable materials for forming projections, e.g., hooks 12 or stems 82, are resins, e.g., thermoplastic resins, that provide the mechanical properties that are desired for a particular application. Suitable thermoplastic resins include polypropylene, polyethylene, acrylonitrile-butadiene-styrene copolymer (ABS), polyamide, e.g., nylon 6 or nylon 66, polyesters, e.g., polyethylene terephthalate (PET) or polybutylene terephthalate (PBT), and blends of these materials. The resin may include additives, e.g., lubricating agents, e.g., silicones or fluoropolymers, solid fillers, e.g., inorganic fillers, e.g., silica or pigments, e.g., titanium dioxide. In some embodiments, lubricating agents are employed to reduce the force required to remove molded hooks from their respective cavities. In some embodiments, an additive is used to improve adhesion of the resin 30 to substrate 14, e.g., an anhydride-modified linear low-density polyethylene, e.g., Plexar® PX114 available from Quantum.

In any of the above embodiments, the overall moment of inertia of the nominal transverse cross-section of the substrate can be greater than 0.00020 in⁴ (0.00832 cm⁴). Examples of substrate inertial moments include 0.00065 in⁴ (0.0271 cm⁴), 0.0050 in⁴ (0.208 cm⁴), 0.040 in⁴ (1.67 cm⁴) and 0.5 in⁴ (20.8 cm⁴).

In any of the above embodiments, the effective modulus of elasticity of the material from which the substrate can be greater than 100,000 psi (6.89×10₈N/m²), e.g., 250,000 psi (1.72×10⁹ N/m²), 750,000 psi (5.17×10⁹ N/m²), 1,000,000 psi (6.89×10⁹ N/m²) or more, e.g., 5,000,000 psi (3.45×10¹⁰ N/m²), 15,000,000 psi (1.03×10¹¹ N/m²) or more, e.g., 30,000,000 psi (2.07×10¹¹ N/m²). The effective modulus of elasticity of the material from which the substrate is formed is measured using ASTM E111-04 at 25 ° C. at fifty percent relative humidity, allowing sufficient time for moisture and temperature equilibration.

In any of the above embodiments, the substrate can be, e.g., a construction material, such as wallboard, window frame, wall panel, floor tile, or ceiling tile.

In any of the above embodiments, in order to improve adhesion of resin to the substrate, it is often advantageous to mold onto a substrate with an average surface roughness of greater than 1 micron, e.g., 2, 3, 4, 5 micron or more, e.g., 10 micron, as measured using ISO 4288:1996(E).

In any of the above embodiments, the projections, e.g., hooks 12 or stems 82, preferably have a density of greater than 300 projections/in² (46.5 projections/cm²), e.g., 500 (77.5 projections/cm²), 1,000 (155.0 projections/cm²), 2000 (310.0 projections/cm²) or more, e.g., 3,500 projections/in² (542.5 projections/cm²).

In any of the above embodiments, the substrate can be pre-heated prior to introducing substrate 14 into the gap 18. Pre-heating is sometimes advantageously used to improve adhesion of the resin 30 (or other resin 152) to substrate 14. It can also be used, when a thermoplastic resin is employed, to prevent over cooling of the thermoplastic resin before entering the nip N.

In any of the above embodiments, substrate 14 can be primed, e.g., to improve the adhesion of resin 30 (or 152) to substrate 14. In some embodiments, the priming is performed just prior to introduction of substrate 14 into the gap 18. Suitable primers include acetone, isobutane, isopropyl alcohol, 2-mercaptobenzothiazole, N,N-dialkanol toluidine, and mixtures of these materials. Commercial primers are available from Loctite® Corporation, e.g., Loctite® T7471 primer.

While certain embodiments have been described, other embodiments are envisioned.

While various locations of an extruder head are specifically shown in FIG. 2, these locations can be applied to any of the embodiments described above.

As another example, while embodiments have been described in which substrates are formed from a single material, in other embodiments, substrates are formed from multiple materials. For example, the substrates can be formed of wood, metal, e.g., steel, brass, aluminum, aluminum alloys, or iron, plastic, e.g., polyimide, polysulfone, or composites, e.g., composites of fiber and resin, e.g., fiberglass and resin.

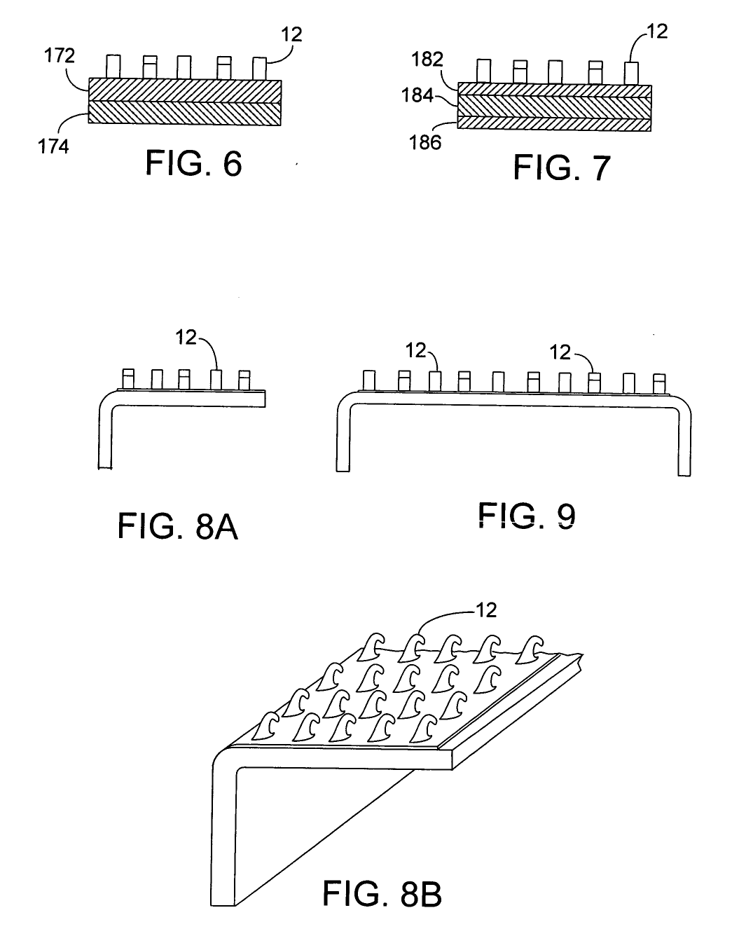

As an additional example, while embodiments have been described in which the base of the fastener is formed of a single layer, in other embodiments, such bases are formed of more than a single layer of material. Referring to FIGS. 6 and 7, a fastener base bonded to a rigid substrate may be formed of two layers 172 and 174 (FIG. 6), and each layer can be a different kind of resin. In still other embodiments, a substrate may be formed of three layers 182, 184 and 186 (FIG. 7). More than three layers are possible.

As a further example, while substrates have been described that are T-shaped and planar in transverse cross-section, other transverse shapes are possible. Referring to FIGS. 8A and 8B, an L-shaped substrate having hooks in which heads are directed in a single direction is shown. Still other shapes are possible. For example, FIG. 9 shows a U-shaped substrate.

While the embodiments of FIGS. 1-3 show resin being continuously delivered to nip N, in some instances it is desirable to deliver discrete doses or charges of resin to the substrate, e.g., to reduce resin costs, so that projections are arranged on only discrete areas of the substrate. This can be done, e.g., by delivering the doses or charges through an orifice defined in an outer surface of a rotating die wheel, as described in “Delivering Resin For Forming Fastener Products,” filed Mar. 18, 2004 and assigned U.S. Ser. No. 10/803,682, the entire contents of which are incorporated by reference herein.

While projections 82 of FIG. 3A are shown to have radiused terminal ends, in some embodiments, projections have non-radiused, e.g., castellated terminal ends, such as some of the projections described in “HOOK AND LOOP FASTENER,” U.S. Ser. No. 10/455,240, filed Jun. 4, 2003, the entire contents of which are incorporated by reference herein.

Still other embodiments are within the scope of the claims that follow.

What is claimed is:

1. A method of molding projections on a substrate, the method comprising:
introducing a substrate having an outer surface into a gap formed between a peripheral surface of a rotating mold roll and a supporting surface, the mold roll defining a plurality of discrete cavities that extend inwardly from the peripheral surface of the rotating mold roll;
delivering a resin to a nip formed between the outer surface of the substrate and the peripheral surface of the rotating mold roll, the outer surface of the substrate and the peripheral surface of the rotating mold roll being arranged to generate sufficient pressure to at least partially fill the cavities in the mold roll as the substrate is moved through the gap to mold an array of discrete projections comprising stems extending integrally from a layer of the resin bonded to the substrate; and then
withdrawing the molded projections from their respective cavities by separation of the peripheral surface of the mold roll from the outer surface of the substrate by continued rotation of the mold roll,
wherein the substrate has a beam stiffness, measured as a product of an overall moment of inertia of a nominal transverse cross-section and an effective modulus of elasticity of a material from which the substrate is formed, that is greater than about 200 lb-in² (0.574 N-m²).

2. The method of claim 1, wherein the beam stiffness is greater than 1,000 lb-in² (2.87 N-m²).

3. The method of claim 2, wherein the beam stiffness is greater than 8,000 lb-in² (22.96 N-m²).

4. The method of claim 1, wherein the effective modulus of elasticity of the material from which the substrate is formed is greater than 100,000 psi (6.89×10⁸ N/m²).

5. The method of claim 1, wherein the supporting surface is a peripheral surface of a counter-rotating pressure roll.

6. The method of claim 5, wherein the pressure roll defines a groove configured to receive a portion of the substrate.

7. The method of claim 1, wherein the cavities of the mold roll are shaped to mold hooks so as to be engageable with loops.

8. The method of claim 7, further comprising reforming the hooks after molding.

9. The method of claim 1, wherein each projection defines a tip portion, the method further comprising deforming the tip portions of a plurality of projections to form engaging heads shaped to be engageable with loops.

10. The method of claim 1, wherein the resin is delivered directly to the nip.

11. The method of claim 1, wherein the resin is delivered first to the outer surface of the substrate upstream of the nip, and then is transferred to the nip.

12. The method of claim 1, wherein the resin is delivered first to the outer surface of the mold roll, and then the resin is transferred to the nip by rotation of the mold roll.

13. The method of claim 1, wherein the substrate has an “L” shape in transverse cross-section.

14. The method of claim 1, wherein the substrate has a “T” shape in transverse cross-section.

15. The method of claim 1, wherein the substrate has a “U” shape in transverse cross-section.

16. The method of claim 1, further comprising introducing a another resin beneath the resin such that the other resin becomes bonded to the outer surface of the substrate and the resin becomes bonded to an outer surface of the other resin.

17. The method of claim 1, wherein the substrate has an average surface roughness of greater than about 1 micron.

18. The method of claim 1, further comprising introducing another material into the nip between the resin and the substrate, to form a tie layer bonding the resin to the substrate.

19. The method of claim 1, wherein the projections have a density of greater than 300 projections/in² (46.5 projections/cm²).

20. The method of claim 1, further comprising pre-heating the substrate prior to introducing the substrate into the gap.

21. The method of claim 1, further comprising priming the substrate prior to introducing the resin to the substrate.

22. A method of molding projections on a substrate, the method comprising:
introducing a linear substrate having an outer surface into a gap formed between a peripheral surface of a rotating mold roll and a supporting surface, the mold roll defining a plurality of discrete cavities that extend inwardly from the peripheral surface of the rotating mold roll;
delivering a resin to a nip formed between the outer surface of the substrate and the peripheral surface of the rotating mold roll, the outer surface of the substrate and the peripheral surface of the rotating mold roll being arranged to generate sufficient pressure to at least partially fill the cavities in the mold roll as the substrate is moved through the gap to mold an array of discrete projections comprising stems extending integrally from a layer of the resin bonded to the substrate; and then
withdrawing the molded projections from their respective cavities by separation of the peripheral surface of the mold roll from the outer surface of the substrate by continued rotation of the mold roll,
wherein the substrate has a beam stiffness sufficiently great that during withdrawal of the molded projections from their respective cavities, the substrate remains substantially linear.

23. The method of claim 22, wherein the beam stiffness of the substrate, measured as a product of an overall moment of inertia of a nominal transverse cross-section and an effective modulus of elasticity of material of the substrate, is greater than about 200 lb-in² (0.574 N-m²).

24. An article having molded fastening projections comprising:
a substrate; and
an array of discrete molded projections comprising stems extending outwardly from and integral with a molded layer of resin solidified about surface features of the substrate and thereby securing the projections directly to the substrate,
wherein the substrate has a beam stiffness, measured as a product of an overall moment of inertia of a nominal transverse cross-section and an effective modulus of elasticity of a material from which the substrate is made, that is greater than about 200 lb-in² (0.574 N-m²).
